(19) United States
(12) Patent Application Publication
(10) Pub. No.: US 2025/0022280 A1
(43) Pub. Date: Jan. 16, 2025

(54) METHOD AND DEVICE FOR GENERATING A SURROUND VIEW, AND MOTOR VEHICLE

(71) Applicants: Continental Autonomous Mobility Germany GmbH, Ingolstadt (DE); Continental Engineering Services GmbH, Frankfurt (DE)

(72) Inventors: Gustavo Machado, Blaustein (DE); Andreas Panakos, Stuttgart (DE); Markus Eich, Ulm (DE); Markus Friebe, Gefrees (DE); Lukas Hutfless, Königstein im Taunus (DE); Philipp Tertel, Frankfurt am Main (DE)

(73) Assignees: Continental Autonomous Mobility Germany GmbH, Ingolstadt (DE); Continental Engineering Services GmbH, Frankfurt (DE)

(21) Appl. No.: 18/711,820

(22) PCT Filed: Nov. 17, 2022
(86) PCT No.: PCT/DE2022/200270

§ 371 Date: May 20, 2024

(30) Foreign Application Priority Data
Nov. 18, 2021 (DE) 10 2021 212 970.6

(51) Int. Cl. G06V 20/56; B60R 1/27; B62D 15/02

(52) U.S. Cl. CPC G06V 20/56; B60R 1/27; B62D 15/0295

(57) ABSTRACT

The present disclosure relates to a method for generating a surround view of the surroundings of a motor vehicle, wherein the motor vehicle has a vehicle body and components which can move relative to the vehicle body, in particular deflectable components. The method includes generating a first mask which represents a silhouette of the vehicle body projected onto a background and generating a second mask which represents a silhouette of the movable components of the motor vehicle projected onto the background in the current state. The method further includes generating a mask of the motor vehicle by combining the first mask with the second mask and generating the surround view of the surroundings of the motor vehicle on the basis of camera images of vehicle cameras of the motor vehicle using the mask of the motor vehicle.

### CROSS-REFERENCE TO RELATED APPLICATIONS

The present application is a National Stage Application under 35 U.S.C. § 371 of International Patent Application No. PCT/DE2022/200270 filed on Nov. 17, 2022, and claims priority from German Patent Application No. 10 2021 212 970.6 filed on Nov. 18, 2021, in the German Patent and Trademark Office, the disclosures of which are herein incorporated by reference in their entireties.

### TECHNICAL FIELD

The invention relates to a method and a device for generating a surround view, as well as a corresponding motor vehicle.

### BACKGROUND

Driver assistance systems can support the driver during maneuvering of the motor vehicle. To this end, camera systems which produce a view of the vehicle surroundings and output the view for the driver can be deployed. The driver can then, for example, be guided by the view when pulling into or out of the parking space in order to maneuver the motor vehicle more quickly and safely.

To this end, surround-view camera systems which can reproduce the entire surroundings of the motor vehicle by merging images of multiple vehicle cameras are known. The real images generated by the cameras can be merged to produce an image of the surroundings.

The vehicle environment can be graphically represented in various perspectives. For example, a “bowl” view is known, in which the textures from the cameras are projected in such a way that a virtual three-dimensional “bowl” is generated, which represents the entire area around the motor vehicle. A further known view is the “top-view” representation (bird's-eye perspective or top view).

Some regions of the vehicle surroundings cannot be detected by the vehicle cameras as they are concealed, for instance, by components of the motor vehicle or are located outside of the field of view of the vehicle cameras, as is the case for instance for the region below the motor vehicle.

A camera system for capturing the environment for a vehicle is known from DE 10 2020 213 146 B3, wherein the vehicle body is detected in a camera image, limiting points from a vehicle body boundary of the vehicle body are stipulated and camera coordinates are converted into a vehicle coordinate system in order to determine the boundary of a camera-free texture.

Parts of the surroundings information can be missing, in particular in terms of those spatial regions which are closer to the vehicle boundaries so as not to make any vehicle parts visible which are, in general, projected onto the ground in an unusual manner.

Even if a conservative approach is used, in which the ground blind region is stipulated as a rectangle having a size which covers all of the vehicle surroundings, there are still regions of the ground which are duly detected by cameras and are covered by said rectangle in the output. In other words, there are blind regions of the ground, typically the regions of the ground in the proximity of vehicle boundaries which are concealed by a rectangular blind region and are not visible in the output of visualizations, e.g., in the top view or bowl view. This adversely affects the visibility of objects in the surroundings during the maneuvering of the vehicle, since these could be concealed by the rectangular blind region.

### SUMMARY

It is therefore an aspect of the present disclosure to make the blind region smaller.

This aspect is addressed by a method and a device for generating a surround view of the surroundings of a motor vehicle and a motor vehicle having the features of the independent claims.

Further embodiments are the subject-matter of the subclaims.

According to a first aspect, the present disclosure accordingly creates a method for generating a surround view of the surroundings of a motor vehicle, wherein the motor vehicle has a vehicle body and components which can move relative to the vehicle body, in particular deflectable components. The method includes generating a first mask which represents a silhouette of the vehicle body projected onto a background and generating a second mask which represents a silhouette of the movable components of the motor vehicle projected onto the background in the current state. The method further includes generating a mask of the motor vehicle by combining the first mask with the second mask and generating the surround view of the surroundings of the motor vehicle on the basis of camera images of vehicle cameras of the motor vehicle using the mask of the motor vehicle.

According to a second aspect, the present disclosure creates a device for generating a surround view of the surroundings of a motor vehicle, wherein the motor vehicle has a vehicle body and components which can move relative to the vehicle body. The device includes an interface which is configured to receive camera images from vehicle cameras of the motor vehicle, and a computing device which is configured to generate a first mask which represents a silhouette of the vehicle body projected onto a background, and to generate a second mask which represents a silhouette of the movable components of the motor vehicle projected onto the background in the current state. The computing device is further configured to generate a mask of the motor vehicle by combining the first mask with the second mask, and to generate the surround view of the surroundings of the motor vehicle on the basis of the received camera images using the mask of the motor vehicle.

According to a third aspect, the present disclosure relates to a motor vehicle having a device according to the present disclosure for generating a surround view of the surroundings of the motor vehicle.

The present disclosure makes it possible to consistently represent all of the regions of the vehicle surroundings, which are visible from the vehicle cameras around the vehicle. This is achieved by constructing a geometric mask of the vehicle which covers the vehicle parts in multi-camera visualizations.

The masks can in each case be defined as polygonal areas.

According to a further development of the method for generating the surround view of the surroundings of the motor vehicle, the movable components include at least one deflectable wheel of the motor vehicle, wherein the second mask is determined as a function of a current steering angle of the motor vehicle. The current position of the wheel can be determined on the basis of the current steering angle.

According to a further development of the method for generating the surround view of the surroundings of the motor vehicle, a virtual wheel is generated for the at least one wheel of the motor vehicle as a function of the current steering angle in a vehicle camera coordinate system of a vehicle camera detecting the wheel of the motor vehicle, wherein the virtual wheel is projected onto the background in the vehicle camera coordinate system from a viewing angle of the vehicle camera in order to generate the silhouette of the wheel of the motor vehicle projected onto the background. Consequently, the mask for the vehicle wheels can be created on the basis of the reprojection of a virtual wheel. The current position of the wheel can be considered.

According to a further development of the method for generating the surround view of the surroundings of the motor vehicle, the virtual wheel is further generated as a function of dimensions and a position of the at least one wheel of the motor vehicle. The dimensions can be specified for the motor vehicle or a model of the motor vehicle.

According to a further development of the method for generating the surround view of the surroundings of the motor vehicle, the virtual wheel is modeled by a cylinder. The cylinder can be described by a grid.

According to a further development of the method for generating the surround view of the surroundings of the motor vehicle, a boundary line which indicates a boundary of the vehicle body in the camera image of the vehicle camera is determined for each vehicle camera. Each boundary line is projected onto the background. Points of intersection of the boundary lines projected onto the background are determined, wherein the silhouette of the vehicle body projected onto the background is established as an area which is enclosed by the sections of the boundary lines which extend between the determined points of intersection. As a result, it can be ensured that no image information is used which reproduces parts of the vehicle body.

According to a further development of the method for generating the surround view of the surroundings of the motor vehicle, the boundary line is automatically determined for each camera image. As a result, the method can be performed more quickly. The automatic determination can be carried out in a model-specific manner, i.e., not individually for each motor vehicle. Further, a virtual three-dimensional model of the motor vehicle can be used. Based on the real camera extrinsics for each vehicle following the calibration, the exact boundary lines can be completely extracted in the virtual surroundings. Another possibility is to use this three-dimensional model of the motor vehicle in order to estimate the polygonal area of the first mask directly from the projection of the virtual vehicle.

According to a further development of the method for generating the surround view of the surroundings of the motor vehicle, the boundary line is generated for each camera image using a virtual model of the vehicle body.

According to a further development of the method for generating the surround view of the surroundings of the motor vehicle, an adjacent overlapping region of detection regions of the vehicle cameras is determined for each determined point of intersection. At least one of the overlapping regions is displaced horizontally to an outer point of the silhouette of a movable component of the motor vehicle projected onto the background. That is to say that the projection regions of the cameras and the overlapping regions can be adjusted in order to avoid the unwanted representation of opaque vehicle parts.

According to a further development of the method for generating the surround view of the surroundings of the motor vehicle, the surround view of the surroundings of the motor vehicle is generated on the basis of the camera images generated by the vehicle cameras, wherein no camera data of the camera images are inserted into regions masked by the mask of the motor vehicle. Instead, an artificial image of the motor vehicle can be inserted.

According to a further development of the method for generating the surround view of the surroundings of the motor vehicle, the surround view of the surroundings of the motor vehicle is a bowl view of the surroundings of the motor vehicle or a top view of the surroundings of the motor vehicle.

According to a further development of the method for generating the surround view of the surroundings of the motor vehicle, the generated surround view of the surroundings of the motor vehicle is displayed on a display device of the motor vehicle. The surround view can be displayed, for instance, when using a parking assistant or during reversing.

According to a further development, the motor vehicle includes a display device which is configured to display the generated surround view of the surroundings of the motor vehicle.

### DESCRIPTION OF THE DRAWINGS

The present disclosure is explained in greater detail below with reference to the example embodiments indicated in the schematic figures of the drawings, wherein:

FIG. 1 shows a schematic block diagram of a motor vehicle having a device for generating a surround view of the surroundings of the motor vehicle according to an embodiment of the present disclosure;

FIG. 2 shows a schematic representation of a camera image in order to explain a boundary line;

FIG. 3 shows schematic representations in order to explain the generation of the first mask;

FIG. 4 shows schematic representations of detection regions of vehicle cameras;

FIG. 5 shows a schematic representation of non-displaced overlapping regions;

FIG. 6 shows a schematic representation of displaced overlapping regions;

FIG. 7 shows schematic representations in order to explain the generation of the mask of the motor vehicle;

FIG. 8 shows a schematic representation of the mask of the motor vehicle; and

FIG. 9 shows a flow chart of a method for generating a surround view of the surroundings of a motor vehicle according to an embodiment of the present disclosure.

### DETAILED DESCRIPTION

Inasmuch as it makes sense, the described configurations and further developments can be combined with one another as desired. Further possible configurations, further developments and implementations of the present disclosure also include combinations of features of the present disclosure described above or below with regard to the example embodiments which are not explicitly mentioned.

The appended drawings are intended to convey a further understanding of the embodiments of the present disclosure. They illustrate embodiments and, in connection with the description, serve to explain principles and concepts of the present disclosure. Other embodiments and many of the indicated advantages are set out with respect to the drawings. The elements of the drawings are not necessarily shown to scale with respect to one another. The same reference numerals denote components which are the same or have a similar effect.

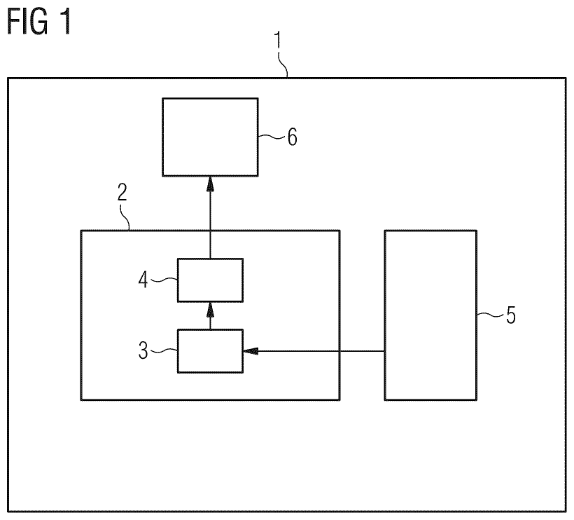

FIG. 1 shows a schematic block diagram of a motor vehicle 1 having a device 2 for generating a surround view of the surroundings of the motor vehicle 1. The motor vehicle 1 includes a vehicle body which, within the meaning of the present disclosure, can include, for instance, a body as well as non-deflectable wheels. Further, the motor vehicle 1 includes components which can move, in particular swivel or deflect, relative to the vehicle body, which can contribute to a change in the silhouette of the motor vehicle 1 (for instance, in a top view). The movable components may include the deflectable wheels of the motor vehicle 1. Further movable components can include deflectable components of construction vehicles or a blade of a snowplow.

The device 2 includes a wireless or wired interface 3 which is coupled to vehicle cameras 5 of the motor vehicle 1 and receives camera images from the vehicle cameras 5. For example, four, six, eight or ten vehicle cameras 5 can be provided. In the case of one embodiment, cameras are in each case arranged in the front region, in the rear region and on the side mirrors. The present disclosure is not limited to a specific number of vehicle cameras 5. The vehicle cameras 5 may be fish-eye cameras having a large detection region of at least 160 degrees.

The present disclosure is provided for any areas of application in which “blind” regions (blind spots) can occur. For example, trailer applications can also be included.

The device 2 has or obtains further knowledge from intrinsic and extrinsic camera parameters of the vehicle cameras 5.

Within the meaning of the present disclosure, intrinsic camera parameters can be internally and permanently coupled to a specific vehicle camera 5. Intrinsic camera parameters accordingly make possible an allocation between camera coordinates and pixel coordinates.

Extrinsic parameters can be external to the camera and change in terms of the world view, i.e., as a function of the location, position and alignment of the vehicle camera 5 in the world coordinate system.

The device 2 further includes a computing device 4 which can have microcontrollers, microprocessors or the like in order to perform calculation operations.

The computing device 4 generates a mask of the motor vehicle 1. To this end, the computing device 4 generates a first mask which represents a silhouette of the vehicle body projected onto a background. That is to say that the first mask can, for example, represent a body mask.

The computing device 4 further generates a second mask which represents a silhouette of the movable components of the motor vehicle projected onto the background in the current state. Consequently, the second mask includes, for example, the deflectable wheels of the motor vehicle 1 in a current wheel position. A virtual wheel model can be used in order to arrange a virtual wheel in the world coordinate system, taking into account current steering angle information, in such a way that it corresponds as precisely as possible to the real wheel position and wheel size. The virtual wheel can be projected in such a way that it is positioned as if the virtual wheel had been detected by the corresponding vehicle camera 5. By way of example, left wheels are projected onto the left camera and right wheels are projected onto the right camera. The virtual wheel model is then projected back onto the ground. The projected virtual wheel models can be cropped at a specific vehicle longitudinal position such that they correspond to a used visualization approach.

The computing device 4 combines the first mask with the second mask in order to generate the mask of the motor vehicle. The mask of the motor vehicle can include all of the regions which are either included by the first mask or by the second mask.

The computing device 4 further generates a surround view of the surroundings of the motor vehicle 1 on the basis of the received camera images, taking into account extrinsic and intrinsic camera parameters of the corresponding vehicle cameras 5. Image information generated on the basis of the camera images is merely projected onto regions which are located outside of the mask of the motor vehicle 1.

The surround view can be output via a display device 6, for instance a vehicle display.

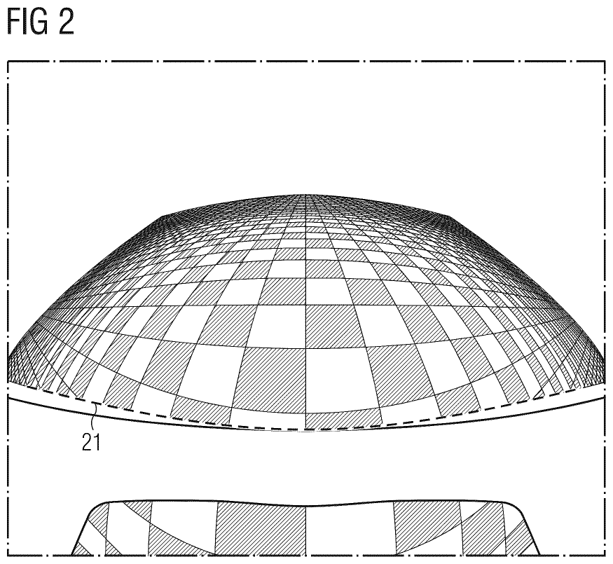

FIG. 2 shows a schematic representation of a camera image in order to explain a boundary line 21 which is enlisted in order to generate the first mask (body mask). Here, the boundary line 21 corresponds in a camera image (for instance, a camera image of a front camera) to the boundary between a region which is assigned to the vehicle body, and a region lying outside, for instance a background.

The boundary lines 21 are generated for each vehicle camera 5. The generation can be carried out automatically or manually. The boundary lines 21 can be determined individually for each motor vehicle 1. Alternatively, the boundary lines 21 can be extracted only once for a specific vehicle model and the projected geometry can be used for all of the motor vehicles 1 of the same model. A small offset can be taken into account in order to increase the size of the first mask and to take account of possible deviations.

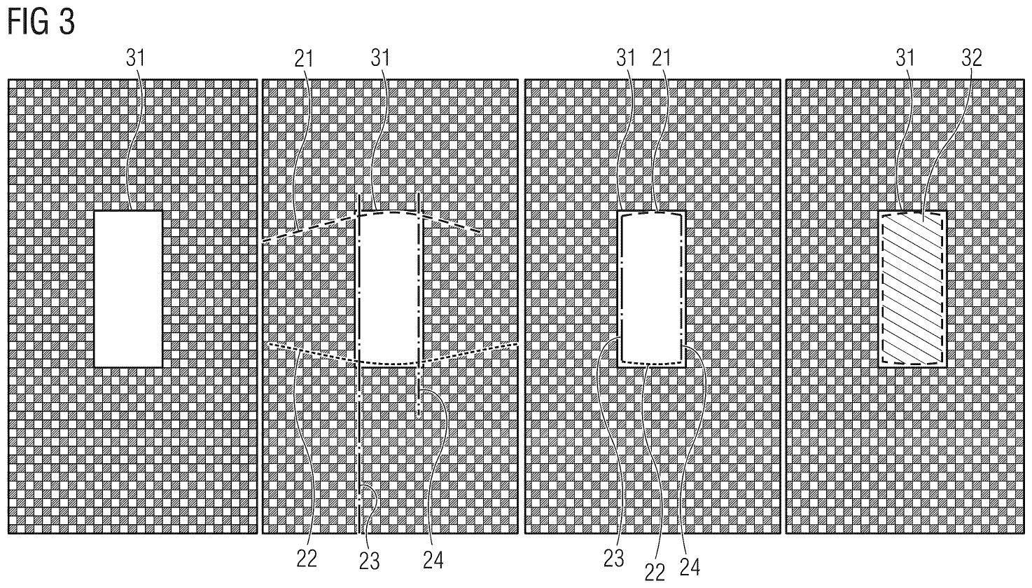

FIG. 3 shows schematic representations in order to explain the generation of the first mask. A top view of the motor vehicle 1 is illustrated. In further embodiments, bowl views can also be used. In a simplest case (FIG. 3, far left), the vehicle body is modeled by a rectangle 31. In order to obtain a more precise model of the vehicle body, the boundary lines 21 to 24 are determined for each of a total of four vehicle cameras of the motor vehicle 1 and projected onto the background (FIG. 3, center left). Further, points of intersection of the boundary lines 21 to 24 projected onto the background are determined, and the boundary lines 21 to 24 are restricted to polygonal sections of the boundary lines 21 to 24 which extend between the determined points of intersection (FIG. 3, center right). The silhouette of the vehicle body projected onto the background, which represents the first mask 32, is determined as an area which is enclosed by these sections of the boundary lines 21 to 24 (FIG. 3, far right).

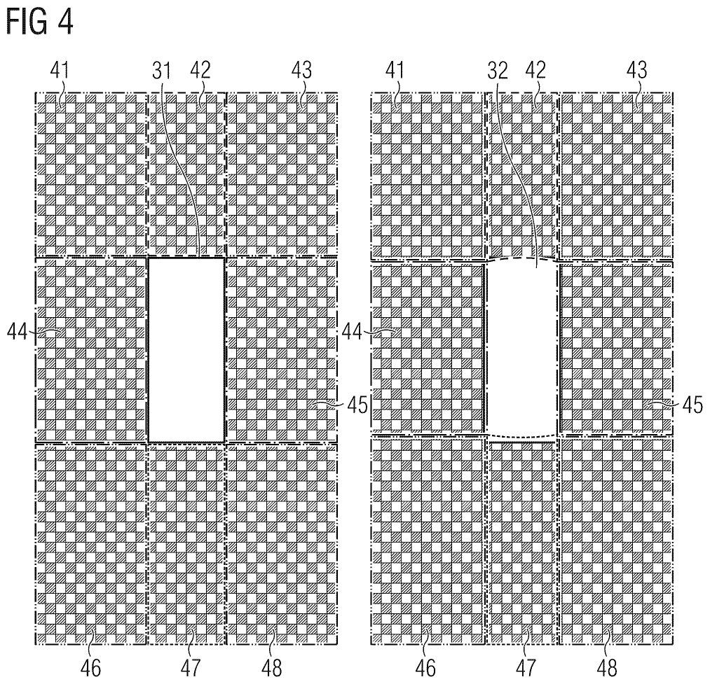

FIG. 4 shows schematic representations of detection regions 41 to 48 from four vehicle cameras 5 of the motor vehicle 1. These detection regions 41 to 48 are initially defined relative to the rectangle 31 modeling the motor vehicle 1. There are four first regions 42, 44, 45, 47 which are in each case only detected by one of the vehicle cameras. Further, there are four second regions 41, 43, 46, 48 which are overlapping regions which are detected by two of the vehicle cameras 5 (FIG. 4 left). Using the first mask 32, the detection regions 41 to 48 are displaced. Furthermore, the overlapping regions 41, 43, 46, 48 have a rectangular form, whilst the first regions 42, 44, 45, 47 have a side delimited by the first mask 32 which does not have to run in a straight line.

FIG. 5 shows a schematic representation of non-displaced overlapping regions 41, 43. If wheels 51, 52 of the motor vehicle 1 are now additionally to be considered, these wheels 51, 52 can project into the non-displaced overlapping regions 41, 43. For this purpose, it is initially determined to what extent the wheels 51, 52 exceed the first mask 32 previously defined by the boundary lines 21 to 24. This is carried out with the aid of a virtual wheel which is generated based on the wheel dimensions, the position and the current steering angle. The virtual wheel can be represented in a cylinder grid model.

The virtual wheel is represented in the vehicle camera coordinate systems as if it had been acquired by the vehicle camera 5. The virtual wheels are subsequently projected onto the ground.

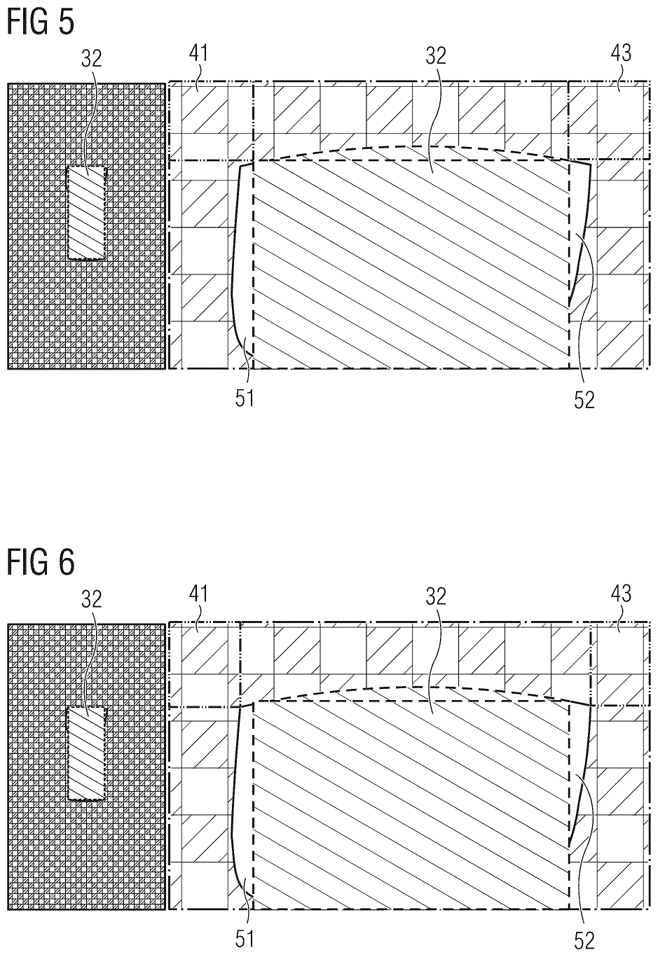

FIG. 6 shows a schematic representation of displaced overlapping regions 41, 43. For each point of intersection of the boundary lines 21 to 24, the adjacent overlapping region 41, 43 of the detection regions of the vehicle cameras is displaced horizontally to an outer point of the silhouette of the corresponding wheel 51, 52 projected onto the background. The overlapping regions 41, 43 are, consequently, treated dynamically. The rectangular overlapping regions 41, 43 are created when using vehicle cameras having a large detection range (fish-eye cameras), i.e., up to 180 degrees. Displacing the overlapping regions 41, 43 prevents parts of the movable and deflected wheels being detected by the side vehicle cameras.

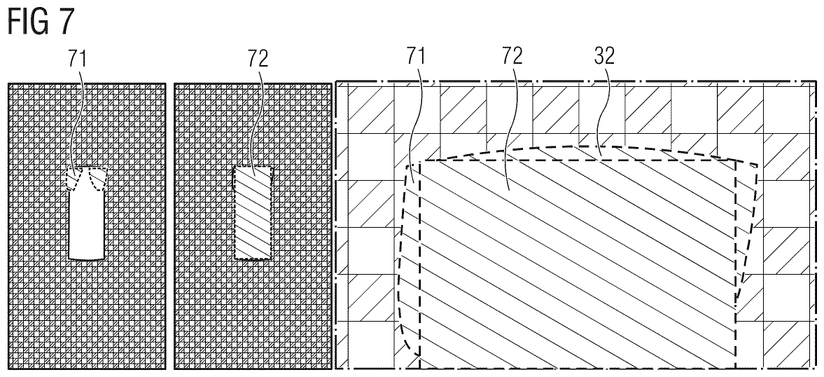

FIG. 7 shows schematic representations in order to explain the generation of the mask 72 of the motor vehicle 1. To this end, the first mask 32 is combined with a second mask 71 of the deflectable wheels of the motor vehicle in order to generate the mask 72 of the motor vehicle 1.

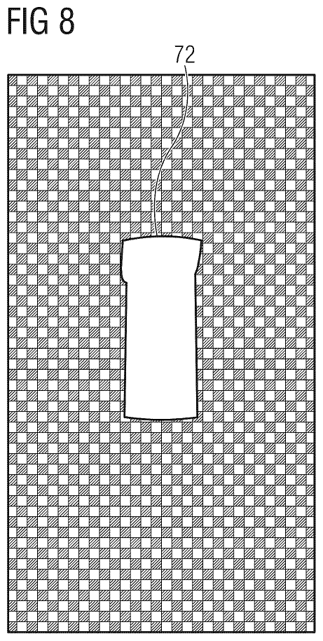

FIG. 8 shows a schematic representation of the mask 72 of the motor vehicle 1. In order to generate the surround view of the surroundings of the motor vehicle 1, the camera images of the vehicle cameras 5 are projected into the region which is not masked by the mask 72 of the motor vehicle 1.

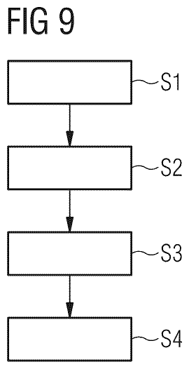

FIG. 9 shows a flow chart of a method for generating a surround view of the surroundings of a motor vehicle 1 according to an embodiment of the present disclosure.

In a first step S1, a first mask 32 is generated, which represents a silhouette of the vehicle body projected onto a background. Further, a second mask is generated in a second step S2 which represents a silhouette of the movable components of the motor vehicle projected onto the background in the current state.

The method further includes generating a mask of the motor vehicle 1 by combining the first mask with the second mask, S3. Finally, a surround view of the surroundings of the motor vehicle 1 is generated on the basis of camera images of vehicle cameras 5 of the motor vehicle 1 using the mask of the motor vehicle 1, S4, which can be output via a display device 6 of the motor vehicle 1.

### LIST OF REFERENCE NUMERALS

1 Motor vehicle
2 Device for generating a surround view
3 Interface
4 Computing device
5 Vehicle cameras
6 Display device
21-24 Boundary lines
31 Rectangle
32 First mask
41-48 Detection regions
51, 52 Wheels
71 Second mask
72 Mask of the motor vehicle
S1-S4 Method steps

1. A method for generating a surround view of the surroundings of a motor vehicle, wherein the motor vehicle has a vehicle body and components which can move relative to the vehicle body, the method comprising:
generating a first mask which represents a silhouette of the vehicle body projected onto a background;
generating a second mask which represents a silhouette of the movable components of the motor vehicle projected onto the background in a current state;
generating a third mask of the motor vehicle by combining the first mask with the second mask; and
generating the surround view of the surroundings of the motor vehicle on the basis of camera images of vehicle cameras of the motor vehicle using the third mask of the motor vehicle.

2. The method according to claim 1, wherein the movable components comprise at least one deflectable wheel of the motor vehicle, and wherein the second mask is determined as a function of a current steering angle of the motor vehicle.

3. The method according to claim 2, wherein a virtual wheel is generated for the at least one wheel of the motor vehicle as a function of the current steering angle in a vehicle camera coordinate system of a vehicle camera detecting the at least one deflectable wheel of the motor vehicle, and wherein the virtual wheel is projected onto the background in the vehicle camera coordinate system from a viewing angle of the vehicle camera in order to generate the silhouette of the at least one deflectable wheel of the motor vehicle projected onto the background.

4. The method according to claim 3, wherein the virtual wheel is further generated as a function of dimensions and a position of the at least one wheel of the motor vehicle.

5. The method according to claim 3, wherein the virtual wheel is modeled by a cylinder.

6. The method according to any one of the preceding claim 1, wherein a boundary line which indicates a boundary of the vehicle body in the camera image of the vehicle camera is determined for each vehicle camera, wherein each boundary line is projected onto the background, wherein points of intersection of the boundary lines projected onto the background are determined, and wherein the silhouette of the vehicle body projected onto the background is established as an area which is enclosed by the sections of the boundary lines which extend between the determined points of intersection.

7. The method according to claim 6, wherein the boundary line is automatically determined for each camera image.

8. The method according to claim 6, wherein the boundary line is generated for each camera image using a virtual model of the vehicle body.

9. The method according to claim 6, wherein an adjacent overlapping region of detection regions of the vehicle cameras is determined for each determined point of intersection, and at least one of the overlapping regions is displaced horizontally to an outer point of the silhouette of a movable component of the motor vehicle projected onto the background.

10. The method according to claim 1, wherein the surround view of the surroundings of the motor vehicle is generated on the basis of the camera images generated by the vehicle cameras, wherein no camera data of the camera images are inserted into regions masked by the third mask of the motor vehicle.

11. The method according to claim 1, wherein the surround view of the surroundings of the motor vehicle is a bowl view of the surroundings of the motor vehicle or a top view of the surroundings of the motor vehicle.

12. The method according to claim 1, wherein further comprising displaying the generated surround view of the surroundings of the motor vehicle is displayed on a display device of the motor vehicle.

13. The device for generating a surround view of the surroundings of a motor vehicle, wherein the motor vehicle has a vehicle body and components which can move relative to the vehicle body, the device comprising:
an interface which is configured to receive camera images from vehicle cameras of the motor vehicle; and
a computing device having at least one processor which is configured:
to generate a first mask which represents a silhouette of the vehicle body projected onto a background;
to generate a second mask which represents a silhouette of the movable components of the motor vehicle projected onto the background in the current state;
to generate a third mask of the motor vehicle by combining the first mask with the second mask; and
to generate the surround view of the surroundings of the motor vehicle on the basis of the received camera images using the third mask of the motor vehicle.

14. A motor vehicle having a device according to claim 13 for generating the surround view of the surroundings of the motor vehicle.

15. The motor vehicle according to claim 14, having comprising a display device which is configured to display the generated surround view of the surroundings of the motor vehicle.
